(19) United States
(12) Patent Application Publication
(10) Pub. No.: US 2004/0166404 A1
(43) Pub. Date: Aug. 26, 2004

(54) Computer clock lithium battery adapter

(76) Inventor: Zoltan Egeresi, Santa Cruz, CA (US)

Correspondence Address: ZOLTAN EGERESI, 5500 COAST RD., SANTA CRUZ, CA, 95060, US

(21) Appl. No.: 10/371,109

(22) Filed: Feb. 24, 2003

(51) Int. Cl. H01M 2/10

(52) U.S. Cl. 429/123; 429/99; 429/100

(57) ABSTRACT

On the computer PC boards configuration and clock information is stored in static memory requiring a small non rechargeable lithium battery for power source. Power requirement is minimal, but the battery is located inside the computer and many users can not change it themselves. Battery level is not monitored, and by not replacing battery on time hardware configuration is lost and may require expensive service call. This Computer Clock Lithium Battery adapter uses a lithium battery sized PC tablet inserted into the PC board's battery location. The PC battery tablet connects to a battery cradle attached outside of the computer housing for a user friendly access. Rechargeable battery in the cradle is trickle charged by a small solar cell therefore eliminating the need for battery replacement. The same system can be adopted in many similar battery installations where lithium battery is used.

### PRIOR ARTS

U.S. Pat. No. 5,148,095 Miller, et al. Sep. 15, 1992 320/13

U.S. Pat. No. 4,611,161 September, 1986 Barker 320/2.

U.S. Pat. No. 4,714,868 December, 1987 Maruyama 320/5.

U.S. Pat. No. 4,760,322 July, 1988 Crampton 320/14.

U.S. Pat. No. 4,829,224 May, 1989 Gandelman 320/2.

U.S. Pat. No. 4,860,185 August, 1989 Brewer et al. 363/41.

### BACKGROUND OF THE INVENTION

1. Field of Invention

This invention relates to the replaceable personal computer (PC) battery which supplies electrical power to the static memory of the PC system for configuration and clock. This invention provides a user friendly rechargeable power source for configuration memory retention in a form of Lithium battery adapter recharging system. There is no voltage level monitoring for the installed battery, which is located on the mother board and most people would not know where it is or when does it need to be replaced and they would be afraid to go inside the computer case. Low voltage level creates corrupted configuration data and interruption of the real clock. Since the clock battery is located inside of the computer, replacing it requires opening up the case, and finding the round battery housing and replacing it.

This lithium battery adapter invention makes the requirement of the memory retention battery obsolete.

The Lithium battery on the mother board is 3.0 VA, and as long as the battery level is above 1.5-2.0 V it is sufficient to hold and retain the hardware configuration and real time clock information.

If memory supply voltage is sufficient, the data is read at the time of the booting sequence.

If the voltage drops below the CMOS's threshold level, data becomes corrupted, and computer may not be able to boot up, or configuration and clock data becomes corrupted.

The object of this invention is to provide a stable power source for non volatile memory retention.

2. Description of Prior Art

All personal computers contain an internal non-rechargeable battery for hardware configuration retention. There is no real warning or indication when the battery needs to be replaced after some 1-3 years of usage. Late battery replacement may require expensive service call for most people to restore lost or corrupted configuration data.

Prior art U.S. Pat. No. 5,148,095 has a recharging system for the older type PC systems but not for the newer Pentium based mother board using Lithium batteries. This prior art has a battery charging circuit connecting to the internal 5.0 V supply of the computer's PSU, reduces and regulates the voltage and charges recharging batteries. Batteries have hard wire connection through a square connector for clock voltage supply. My invention, the computer clock lithium battery adapter uses solar battery for power source, trickle charges the rechargeable batteries and applies the power with the PC (Printed Circuit) tablet in the battery housing. PC tablet is the same size as the replaced Lithium battery with plus and minus leads.

### BRIEF DESCRIPTIONS OF THE INVENTION

My invention provides an uninterrupted constant low current supply to the rechargeable battery which connects to a special PC (printed circuit) tablet. The PC tablet is the adapter, a two-layer top/bottom PC board with insulator in between, the same size and shape as the lithium battery, it gets inserted into the lithium battery socket, it has a plus and minus lead which connects to the battery cradle attached to the outside of the computer case for an easy access providing uninterrupted power supply.

Rechargeable batteries are trickle charged by solar cells, since current requirement is very low, ambient room light generates sufficient amount of power without any requirement for using voltage regulators.

The lithium battery adapter, the PC tablet can also be used with disposable batteries with external cradle, since this type of batteries are more expensive, it makes economic sense in many cases to us this type of adapters where physical limitations are not present.

### DETAILED DESCRIPTION OF THE INVENTION

My invention provides an uninterrupted constant low current supply to the rechargeable battery which connects to a special PC (printed circuit) tablet.

FIG. 2 shows a standard lithium battery(2) metal casing top is positive, bottom is negative.

The PC tablet(3) on FIG. 1 and FIG. 3 is the adapter, a two-layer top/bottom PC board with insulator(1) in between, the same size and shape as the lithium battery(2), it gets inserted into the lithium battery socket (9) as shown on FIG. 5.

PC tablet(3) has a plus and minus leads(4) which connect to the battery cradle(5) attached to the outside of the computer case for an easy access providing uninterrupted power supply.

Rechargeable batteries are trickle charged by solar cells, since current requirement is very low, ambient room light generates sufficient amount of power without any requirement for using voltage regulators.

The lithium battery adapter, the PC tablet can also be used in applications other than computer PC mother board, can be used with disposable batteries with external cradle, since this type of batteries are more expensive, it makes economic sense in many cases to us this type of adapters where physical limitations are not present.

In respect, after explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. It is important, therefore, that the claims be regarded as including such equivalent constructions insofar as they do not depart from the spirit and scope of the present invention, nor is it intended to be limiting as to the scope of the invention in any way.

1. What I claim is as a new utility invention is the Computer clock lithium battery adapter and asking the US Patent office to review my claim as a new design. This application has one claim.
Currently manufactured computer motherboards have an on board round, flat lithium battery with a special battery housing to supply power for the configuration memory and clock system.
Battery replacement is not a user friendly or easy chore for most people, and there is no low voltage warning system to prevent configuration memory loss requiring a trip to a local computer store plus service charges. This low cost invention prevents the clock and configuration memory loss.
My invention provides an uninterrupted constant low current supply to the rechargeable battery which connects to a special PC (printed circuit) tablet. The PC tablet is the adapter, the same size and shape as the lithium battery, it gets inserted into the lithium battery socket, it has a plus and minus lead which connects to the battery cradle attached to the outside of the computer case for an easy access.
Rechargeable batteries are trickle charged by solar cell, since current requirement is very low, ambient room light generates sufficient amount of power without any requirement for using voltage regulators.
This is a lower cost battery back up system than prior arts can provide for computer clock and memory retention. The PC tablet lithium battery adapter is adaptable to the newer type computer motherboards and to any other PC circuit systems where similar Lithium battery is with solar cells or with disposable batteries.
